(19) United States
(12) Patent Application Publication
(10) Pub. No.: US 2008/0052242 A1
(43) Pub. Date: Feb. 28, 2008

(54) SYSTEMS AND METHODS FOR EXCHANGING GRAPHICS BETWEEN COMMUNICATION DEVICES

(75) Inventors: Eric Paul Merritt, Lehi, UT (US); Ammon Jackson Diether, American Fork, UT (US); Brett Arthur Nord, Draper, UT (US)

Correspondence Address: STOEL RIVES LLP - SLC, 201 SOUTH MAIN STREET, ONE UTAH CENTER, SALT LAKE CITY, UT, 84111, US

(73) Assignee: GoFigure! LLC, Draper, UT (US)

(21) Appl. No.: 11/466,709

(22) Filed: Aug. 23, 2006

(51) Int. Cl. G06Q 99/00

(52) U.S. Cl. 705/59; 705/51

(57) ABSTRACT

Systems and methods are provided for distributing graphic assets among users of personal communication devices. The graphic assets may include, for example, an avatar and/or avatar accessories used to exchange messages over cellular telephones. A method includes providing an authorized first user with an authoring version of the graphic asset. The authoring version allows the first user to morph the graphic asset and use the graphic asset to send a message to a second user. If the second user is not licensed to use the graphic asset, the second user can view the graphic asset to receive the message from the first user. However, the second user cannot morph the graphic asset or use the graphic asset to send messages until licensed to do so. The graphic asset may include marketing information such as a link to an owner of the graphic asset for licensing purposes.

### TECHNICAL FIELD

This disclosure relates generally to personal communication systems. More specifically, the disclosure relates to communicating a message and marketing information using a customizable graphic asset.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of an exemplary system for communicating with, creating, marketing, and distributing graphic assets according to one embodiment;

FIGS. 2A and 2B are block diagrams of a system for marketing and distributing graphic assets between a first user and a second user according to one embodiment;

FIG. 3 illustrates a data structure of a graphic asset according to one embodiment;

FIG. 4 represents a flattened file useful for rendering avatars;

FIG. 5 graphically illustrates an avatar according to one embodiment;

FIG. 6 is a graphical representation of an example naming scheme for image layer files according to one embodiment;

FIG. 7 is a flow chart illustrating a method for distributing a graphic asset according to one embodiment; and

FIG. 8 is a flow chart illustrating a method for marketing graphic assets according to one embodiment.

### DETAILED DESCRIPTION

Personal communication devices such as cellular telephones, other types of digital phones or radios, personal digital assistants, desktop computers, laptop computers, or the like are widely used to send text and/or voice messages between users. Such messages may include two-dimensional (2D) or three-dimensional (3D) graphics. For example, avatars are 2D or 3D graphic images that are used to visually represent a user in a virtual environment such as an online chat room, a video game, a telephone having a video display, or the like.

An avatar may have the appearance or characteristics of the user or another person. Alternatively, the user's avatar may have the appearance of an animal, a cartoon character, or any object or symbol. An avatar can be used to express a user's unique personality. Thus, according to certain embodiments disclosed herein, users are provided the opportunity to purchase (e.g., license) and modify graphic assets such as avatars and/or avatar accessories. Avatar accessories may include, for example, virtual shirts, pants, shorts, socks, hats, headbands, wristbands, shoes, glasses, headphones, logos, tattoos, hair styles, jewelry, animation, and the like.

In one embodiment, a user who purchases access rights to a graphic asset can also send the original or modified graphic asset to another user as part of a personal message. For example, a text message may be displayed in a bubble or cloud next to a sender's avatar on a receiving party's cellular telephone (cell phone). In addition, or in another embodiment, the sender's avatar may appear to speak or make gestures as the sender delivers a voice message to the receiving party.

In one embodiment, graphic assets such as avatars and/or avatar accessories are marketed and sold to users through viral marketing. In other words, graphic assets and marketing information regarding the graphic assets spread from user to user. The graphic assets may change in color, form, and texture as successive users make modifications. Thus, the graphic assets may become more appealing as they are spread. In addition, or in other embodiments, each successive user that purchases a graphic asset gains access to an original version of the asset.

For example, a first user may send a first avatar to a second user as part of a message. The avatar may be wearing a virtual baseball cap that the second user would like to put on a second avatar when sending messages. When the second user tries to put the baseball cap on the second avatar, however, the second user is notified that the second user does not have rights to use the baseball cap. In one embodiment, the virtual baseball cap provides the second user with a link to, for example, a publisher's portal where the second user can learn more about the baseball cap and buy a license to use it in the second user's messages to other users.

When communication between two personal communication devices share graphic assets such as proprietary avatars and/or avatar accessories, a sending device sends data that has been licensed from a third party (e.g., an author or a publisher). A receiving device receives and renders the graphic asset for display as part of a personal message from the sending device. However, in one embodiment, the licensed data includes security measures that prevent the receiving device from reusing the graphic asset without a license.

In one embodiment, the graphic asset comprises a dataset including a 3D geometry and associated image and data files for the graphic asset. The dataset represents content that the sender has licensed from one or more licensors for use on the sending device. When the receiving device receives the dataset, the dataset communicates a message from the sender. Although the receiving device now has the dataset, the receiving device cannot use the dataset to send a message. For example, in one embodiment, a portion of the dataset that provides for the creation and/or sending of personal messages is encrypted.

If the receiving party desires to use any part of the dataset to send a message, the receiving party can also purchase a license from the one or more licensors. After purchasing the license, in certain embodiments, a new dataset is sent to the receiving party to replace the encrypted dataset received from the other user's sending device. The new dataset provides the receiving party full functionality to use the new dataset in a message.

In one embodiment, each dataset includes marketing information about the individual parts that make up the that dataset. The marketing information includes authorship and publisher information. One purpose of the marketing information is to provide easy connectivity to the licensor for the purpose of purchasing a licensed, fully functional version of the dataset.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, propagation media or other types of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

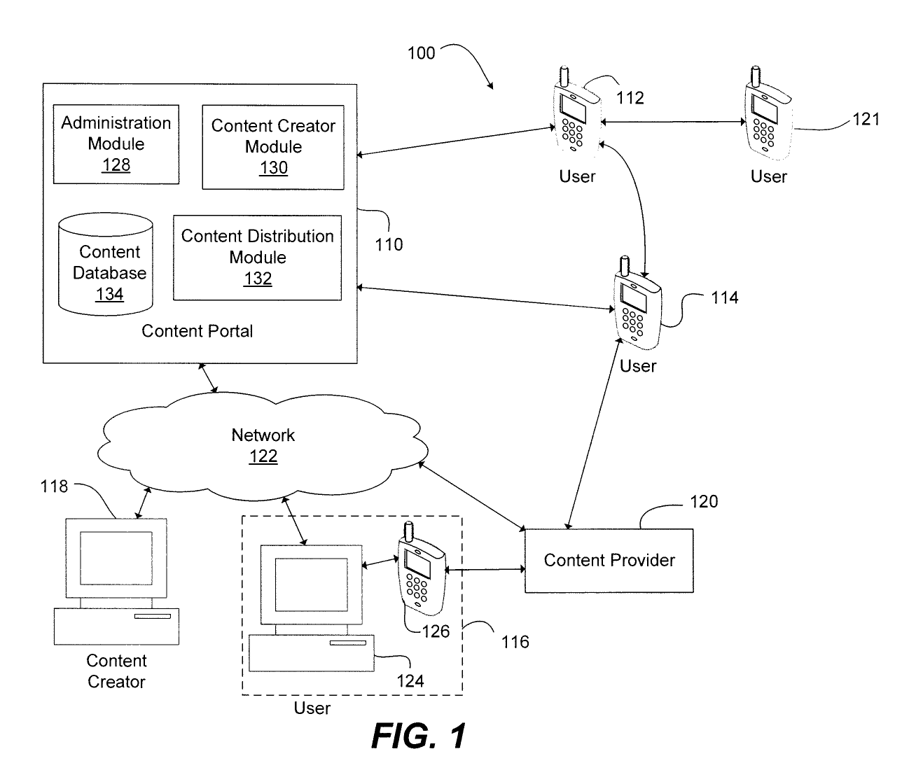

FIG. 1 is a block diagram of an exemplary system 100 for communicating with, creating, marketing, and distributing graphic assets according to one embodiment. The system includes a content portal 110 in communication with one or more users 112, 114, 116, one or more content creator 118, and one or more content provider 120. An artisan will recognize from the disclosure herein that the content portal 110 may be in communication with any number of users 112, 114, 116, content creators 118, and content providers 120. Further, certain aspects of the disclosure may be achieved without communication between one or more of the users 112, 114, 116, content creators 118, and content providers 120.

The users 112, 114, 116 may have personal communication devices such as cell phones, other digital phones or radios, personal digital assistants, desktop computers, laptops, combinations of the foregoing, or other communication devices configured to receive messages and display graphic assets. In this example, the users 112, 114 have cell phones in direct communication (e.g., through a cellular telephone network) with the content portal 110. Thus, the users 112, 114 can send and receive messages directly to/from the content portal 110. The users 112, 114 can also directly communicate with each other, the user 116, and one or more other users 121.

Further, in this example embodiment, the user 116, the content creator 118, and the content provider 120 communicate with the content portal 110 through a network 122. The network 122 may include, for example, the Internet or World Wide Web, or an intranet such as a local area network (LAN) or wide area network (WAN), or any other network of communicating devices. The user 116 may have, for example, a computer 124 for communicating with the content portal 110 through the network 122 and a cell phone 126 capable of communicating with the computer 124 to download graphic assets from the content portal 110.

The content portal 110 and the devices used by the user 116, the content creator 118 and the content provider 120 comprise any processor controlled device that permits access to the network 122, including terminal devices, such as personal computers, workstations, servers, mini-computers, hand-held computers, main-frame computers, laptop computers, mobile computers, set top boxes for televisions, combinations thereof, or the like.

Although not shown, the content portal 110 includes memory, a database manager, and one or more communication interfaces for communicating through the network 122 and/or a cellular telephone network. In one embodiment, the content portal 110 coordinates the creation, marketing, licensing, distribution, and payment for graphic assets such as avatars and avatar accessories. The avatar accessories may include, for example, shirts, pants, shorts, socks, hats, headbands, wristbands, shoes, glasses, headphones, logos, tattoos, hair styles, jewelry, animation, and the like. Once purchased or licensed, an authorized user 112, 114, 116 can use the graphic asset to send a message to another user 112, 114, 116, 121.

The content portal 110 includes an administration module 128, a content creator module 130, a content distribution module 132, and a content database 134. In one embodiment, the administration module 128 allows an administrator (not shown) to manage development, testing, marketing and sales of the graphic assets. For example, the administration module 128 may provide a web page interface to the administrator. The administrator can use the web page interface to view or download graphic assets, modify graphic assets, upload graphic assets, track licensing statistics and revenues, and communicate with the content creator 118 to coordinate efforts to create and test the graphic assets.

The administrator may include, for example, a cell phone service provider, a cell phone manufacturer, a creator of avatars and/or avatar accessories, a group of avatar and/or avatar accessory creators, a digital content provider, a combination of the foregoing, or the like. In one embodiment, the administrator is the content provider 120 shown in FIG. 1 and has access to the administration module 128 through the network 122.

In another embodiment, the content provider 120 is a third party provider of graphic assets. For example, the content provider 120 may be a motion capture studio owner with a library of stock motion files useful for animating avatars. The content provider 120 may provide graphic assets to the content portal 110 for storage, marketing and distribution. In addition, or in other embodiments, the content provider 120 may provide graphic assets directly to the users 112, 114, 116.

The content creator module 130 provides a web page that allows the content creator 118 to download developer tools, communicate with the administrator or an assigned representative of the administrator, submit graphic assets for licensing and distribution to the users 112, 114, 116, and track licensing revenues generated through the content portal 110. The content creator module 130 may also provide the content creator 118 with tutorials, updated online documentation, a support forum, and other information for creating graphic assets for distribution through the content portal. The graphic assets submitted by the content creator 118 are stored in the content database 134.

The content creator 118 may be, for example, a 3D graphical artist that creates avatars and/or avatar accessories. In one embodiment, the content creator 118 can develop the avatars and/or avatar accessories using conventional 3D development tools. The content creator 118 may then use a content toolkit downloaded from the content creator module 130 to format the avatars and/or avatar accessories so as to selectively allow user modification and usage rights, provide marketing information, and operate with software applications available for download from the content distribution module 132. An example format is discussed in detail below.

As another example, the content creator 118 may be a software developer that develops animation applications. The animation applications can be executed for example, on an avatar engine downloadable from the content portal 110 for use on a graphics application programming interface (API) such as OpenGL for embedded systems (OpenGL ES) as defined by the Khronos Group (see w/w.khronos.org/opengles/). An artisan will recognize from the disclosure herein that other 2D or 3D graphics APIs could also be used. The content creator 118 may build, for example, an application to make avatars dance to the beat of an MP3 file. The content creator 118 may include text to speech (TTS) functionality for use in the animation application. The downloadable avatar engine allows the content creator 118 to build the animation application to execute on a cell phone, for example, without knowing what particular TTS engine will be included on the particular cell phone. Thus, the content creator 118 can concentrate efforts on driving avatar rigs with MP3 files.

In one embodiment, the content creator module 130 provides the content creator 118 with, for example, a base figure geometry (e.g., in lightwave object (lwo) format), base texture files (e.g., in photoshop document (psd) format), scripts for rigging (e.g., perl scripts for use in Modo available from Luxology, LLC), standards documentation, product promotion guidelines, video tutorials, contracts and tax forms, a content creator startup checklist, access to content creator forums, assignment of an administrator representative, animation tools, combinations of the foregoing, and other tools to help the content creator 118 create, market and distribute graphic assets.

The content distribution module 132 provides a web page and/or a cell phone interface to allow the users 112, 114, 116 to browse, purchase (e.g., license access rights), and download graphic assets stored in the content database 134. In one embodiment, the users 112, 114, 116 can download and view trial content such as avatars and/or avatar accessories in a target application. However, the users 112, 114, 116 cannot save the trial content in non-volatile memory until the content is purchased. In one embodiment, the trial content is time stamped at the time of download and the target application deletes the trial content after a predetermined evaluation time (e.g., after approximately one hour after being downloaded). The trial content may be downloaded earlier than the predetermined evaluation time, for example, if it is removed from volatile memory (e.g., RAM).

Purchased content may be saved to a cell phone's non-volatile memory. For example, while browsing a virtual clothing store provided by the content distribution module 132, the user 112 may decide to license access rights to a particular virtual shirt for use with the user's avatar. The user 112 can then save the virtual shirt to non-volatile memory in the user's cell phone, modify the virtual shirt, put the shirt on the user's avatar, and send a message to another user 114, 116, 121 using the avatar and the virtual shirt.

After the virtual shirt is purchased, the user 112 can re-download and save the virtual shirt from the content distribution module 132 using the phone number associated with the user's cell phone. Thus, if the purchased virtual shirt is accidentally removed or purposefully removed from the cell phones non-volatile memory, the user 112 can re-download and re-save the virtual shirt, if desired, for further use. In one embodiment, if the user 112 changes cell phones and/or phone numbers, account information in the content distribution module 132 corresponding to the user 112 is updated to reflect the change.

For example, the user 112 may desire to remove the virtual shirt from the user's cell phone to free memory space for additional graphic assets. The user 112 can use the content distribution module as a virtual closet by deleting the virtual shirt from the user's cell phone when it is not being used with the user's avatar. In one embodiment, the content distribution module 132 provides the user 112 with a list of items in the user's virtual closet to make it easier for the user 112 to quickly locate and re-download purchased items.

After the user 112 has purchased the virtual shirt, the user 112 can modify the virtual shirt and/or send a message comprising the user's avatar wearing the virtual shirt to one or more of the other users 114, 116, 121. For example, the user 112 may send the message comprising the user's avatar wearing the virtual shirt to the user 121. The user 121 can view the message including the virtual shirt. However, the user 121 cannot modify the virtual shirt, put the virtual shirt on another avatar corresponding to the user 121, or send a message using the virtual shirt.

As discussed in detail below, in one embodiment, the virtual shirt includes marketing information. The marketing information may include, for example, authorship and/or publisher information corresponding to the virtual shirt. The marketing information may also include a link (e.g., a hyperlink) so as to provide easy connectivity to the licensor of the virtual shirt for purchasing a licensed, fully functional version of the virtual shirt.

For example, the user 112 may send a message comprising the user's avatar wearing the virtual shirt to the user 114. If desired, the user 114 can use the link in the marketing information to access the content distribution module 132 to purchase the virtual shirt. In one embodiment, the user 114 can then select whether to download a new copy of the virtual shirt from the content distribution module 132 or gain access rights to the version of the virtual shirt provided by the user 112, or both. After using the content distribution module 132 to purchase the virtual shirt, the user 114 can then modify the virtual shirt and/or send a message comprising the user's own avatar wearing the virtual shirt.

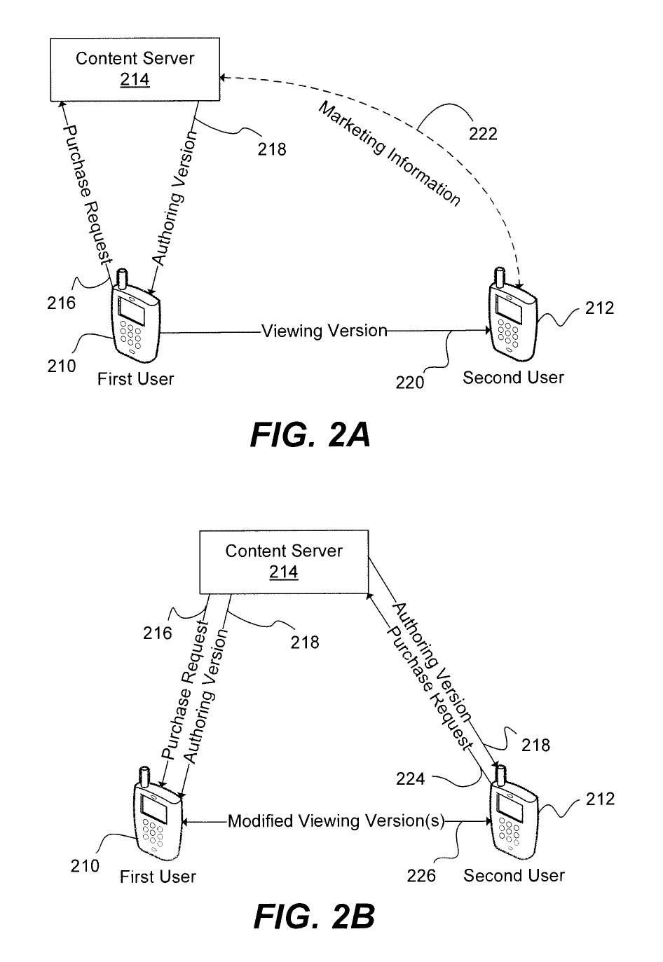

FIGS. 2A and 2B are block diagrams of a system for marketing and distributing graphic assets between a first user 210 and a second user 212 according to one embodiment. In this example embodiment, the first user 210 and the second user 212 directly exchange messages between cell phones using a cellular telephone network. However, as discussed above, an artisan will recognize that the first user 110 and the second user 112 can also exchange messages using other types of digital telephones or radios, personal digital assistants, desktop computers, laptop computers, combinations of the foregoing, or other personal communication devices configured to receive messages and display graphic assets.

The messages sent between the first user 210 and the second user 212 comprise one or more graphic assets. In this example embodiment, the messages sent from the first user 210 to the second user 212 comprise a first avatar (not shown) representing the persona of the first user 210. Similarly, as discussed in relation to FIG. 2B, the messages sent from the second user 212 to the first user 210 comprise a second avatar (not shown) representing the persona of the second user 212.

The avatars are associated with text, speech, and/or animation that communicates a message between the users 210, 212. For example, a message sent from the first user 210 to the second user 212 may include text displayed on or next to the first avatar (e.g., in a text cloud or bubble). In addition, or in other embodiments, the first avatar may be animated to display gestures that communicate emotion or thoughts. As another example, the message may include animating the first avatar's mouth to move with the first user's voice to audibly and visually communicate a message to the second user 212.

In FIG. 2A, the first user 210 downloads the first avatar and/or one or more avatar accessories from a content server 214. In one embodiment, the content server 214 comprises a content portal such as the content portal 110 discussed above in relation to FIG. 1. To purchase access rights to the avatar and/or avatar accessories, the first user 210 sends a first purchase request 216 to the content server 214.

The first purchase request 216 includes data to set up or identify an account corresponding to the first user 210. The first purchase request 216 may also include billing information such as the first user's credit card number or an identification of a third party payment service. In one embodiment, the content server 214 is operated by or associated with a cellular service provider and the account and/or billing information is associated with the phone number of the first user's cell phone.

In response to the first purchase request 216, the content server 214 provides the first user 210 with an authoring version 218 of the requested avatar and/or avatar accessory. With the authoring version 218, the first user 210 has access to any personalization options built into the avatar and/or avatar accessory. As discussed in detail below, in one embodiment, the authoring version 218 comprises a data structure that allows authorized users to change morph targets, animation, colors and other characteristics of the graphic asset. For example, the first user 210 can purchase access to a virtual pair of pants for the first avatar. The first user 210 can change the length of the pants on the first avatar and/or change the color of the pants from pink to blue.

Because the first user 210 has purchased access rights to the requested avatar and/or avatar accessory, the first user 210 can send a viewing version 220 of the first avatar and accessories to the second user 212. As discussed above, in one embodiment, the first user 210 sends the viewing version 220 directly to the second user 212 through a cellular network such that the second user 212 can render and view the first avatar and associated accessories without communicating with the content server 214. In one embodiment, the first user 210 does not send a rendering of the first avatar and accessories to the second user 212. Rather, the second user 212 receives the viewing version 220 and renders the first avatar and accessories therefrom in real time.

By way of example, if the first user 210 sends the second user 212 a viewing version 220 of the first avatar wearing a particular hat, the second user 212 (e.g., an application running on the second user's cell phone) can render the viewing version 220 so as to view the hat on the first avatar. However, the second user 212 cannot put the hat on the second avatar corresponding to the second user 212. Further, the second user 212 cannot modify, save, or send a message using the hat.

As discussed below, the viewing version 220 includes marketing information that includes a marketing link 222 to the content server 214. If the second user 212 wants additional information regarding, for example, the hat worn by the first avatar, the second user 212 can use the marketing link to request and receive information from the content server 214 regarding the source of the hat and purchasing the hat for use with the second avatar. Similarly, if the second user 212 attempts to send the viewing version 220 to another user, the second user 212 may be informed that he or she needs to purchase the authoring version 218, and the marketing link may be used to direct the second user 212 to the content server 214. In one embodiment, the second user 212 may be able to save and view the viewing version 220 within his or her cell phone and use it locally (e.g., add a virtual shirt to one or more avatars for local viewing only), but cannot send the viewing version 220 to another user.

In one embodiment, the first user 210 receives points or credits when the second user 212 accesses the marketing link to the content server 214. In addition, or in other embodiments, the first user 210 receives points or credits when the second user 212 purchases an avatar and/or avatar accessory introduced to the second user 212 by the first user 210. The first user 210 can use the points or credits to purchase additional avatars and/or avatar accessories from the content server 214. Thus, the first user 210 is given an incentive for using the hat, for example, in the message to the second user 212, and to as many other users as possible.

As shown in FIG. 2B, the second user 212 may send a second purchase request 224 to the content server 214. The second purchase request 224 includes data to set up or identify an account corresponding to the second user 212. The second purchase request 224 may also include billing information such as the second user's credit card number or an identification of a third party payment service. In response to the second purchase request 224, the content server 214 provides the second user 212 with the authoring version 218 of the requested avatar and/or avatar accessory.

With the authoring version 218, the second user 212 has access to any personalization options built into the avatar and/or avatar accessory. Thus, for example, the second user 212 can further modify the hat sent by the first user 210. The second user can put the modified hat on the second avatar and send it to the first user 210 as a modified viewing version 226. The first user 210 and the second user 212 may continue to send modified viewing versions 226 to one another, thereby increasing their use of the cellular telephone system. In certain embodiments, the first and second users' increased use in the cellular telephone system provides a financial benefit to the service provider of the cellular telephone system.

In addition, the first user 210 and the second user 212 can both send viewing versions of purchased avatars and/or avatar accessories to other users (not shown). As discussed above, both the first user 210 and the second user 212 may receive points or credits for sending viewing versions of the purchased avatars and/or avatar accessories to the other users. In addition, or in other embodiments, the first user 210 and the second user 212 may respectively receive points or credits when the other users access the content server 214 and/or purchase an avatar or avatar accessory that they recommend.

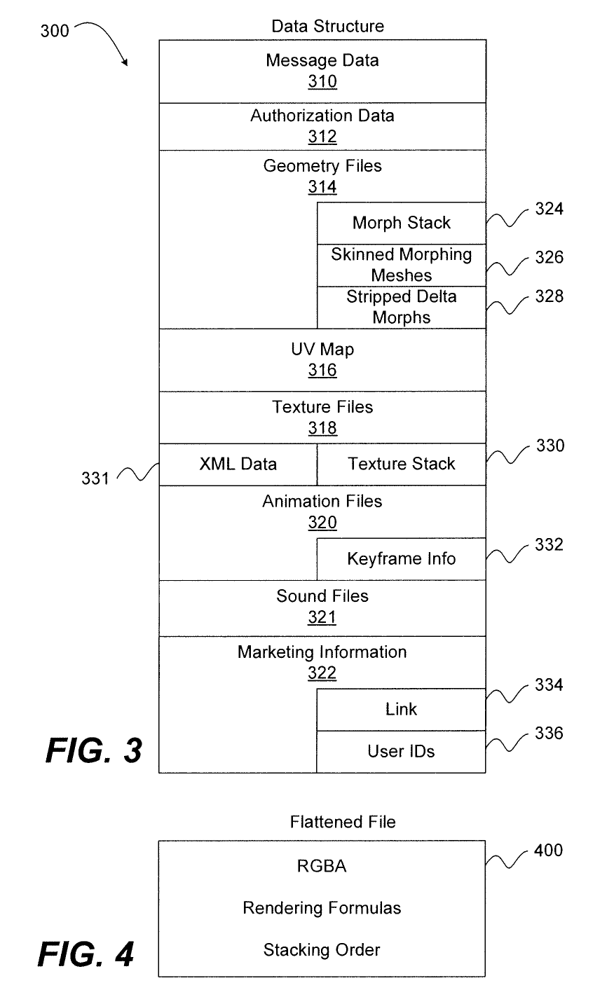

FIG. 3 illustrates a data structure 300 of a graphic asset according to one embodiment. The graphic asset may comprise, for example, a customized message for an intended recipient of the data structure 300 and an avatar and/or avatar accessories. In this example, the graphic asset comprises data for both an avatar and avatar accessories. The data structure 300 allows a user to add, remove and modify selected body parts and accessories without changing other portions of the avatar or accessories.

The data structure 300 includes fields for message data 310, authorization data 312, geometry files 314, a UV map, texture files 318, animation files 320, sound files 321, and marketing information 322. The message data 310 includes text and/or audio data that a user desires to send to a recipient. In one embodiment, the user may select text from a list of predetermined messages (e.g., “how are you?”, “do you like my new hat?”, “cool avatar!”). In addition, or in other embodiments, the user can create custom text or voice messages to include with the user's avatar.

The authorization data 312 is used to lock or unlock access to other portions of the data structure 300. For authoring versions of the data structure 300, according to one embodiment, the authorization data 312 includes one or more keys for decrypting portions of the geometry files 314 and/or texture files 318. The authorization data 312 may also include data for allowing the user to edit the message data and save the data structure 300 to non-volatile memory.

In viewing versions of the data structure 300, the user is denied access to at least a portion of the geometry files 314 and the texture files 318. Thus, as discussed below, the user is unable to morph the avatar or separate out individual accessories for modification or storage. In one embodiment, the authorization data 312 does not include the decryption keys or the user does not have access to the decryption keys. Thus, the user cannot decrypt the encrypted portions of the geometry files 314 and/or the texture files 318 for editing the avatar and/or the avatar accessories. In addition, the user cannot edit information in the message data 310 or save the data structure to non-volatile memory.

In another embodiment, the viewing version of the data structure 300 only includes data used to display the avatar and accessories on a target cell phone. In such an embodiment, the viewing version of the data structure 300 does not include, for example, the geometry files 314 or the texture files 318. The UV map 316 is a 2D map representing the 3D avatar and accessories and is used to render the avatar and accessories on the target cell phone. In addition, or in other embodiments, information for rendering the avatar and accessories on the target cell phone are also provided. For example, FIG. 4 represents a flattened file 400 useful for rendering avatars. The flattened file 400 may include, for example, a defined RGBA (red, green, blue, alpha) color space for the avatar, rendering formulas, and a stacking order.

The geometry files 314 allow users to add accessories to avatar body parts. For example, sunglasses can be parented to the avatar's head. Thus, the user can swap out body parts and outfits as if playing with paper dolls. In one embodiment, seams are defined at specified vertex rows where graphical geometries are automatically combined or “sewn” together.

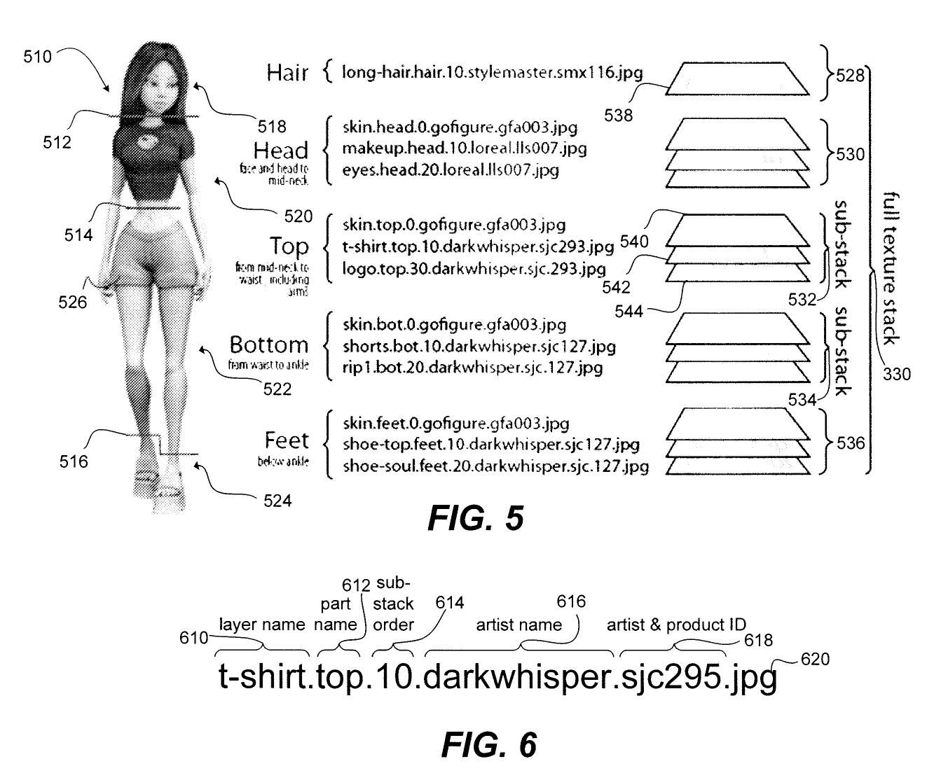

For example, FIG. 5 graphically illustrates an avatar 510 according to one embodiment. The avatar 510 comprises a first seam 512 defining an intersection of a head portion 518 and a top portion 520 of the avatar 510, a second seam 514 defining an intersection of the top portion 520 and a bottom portion 522 of the avatar 510, and a third seam 516 defining an intersection of the bottom portion 522 and a feet portion 524 of the avatar 510. An artisan will recognize from the disclosure herein that other seams can be defined for intersections of other portions (e.g., arms/top, hands/arms, legs/bottom, legs/feet).

The user can swap out combinations of body parts and accessories. For example, if a user selects knee-high boots, both the bottom portion 522 and the feet portion 524 are swapped out together. The body parts and accessories have corresponding skinned morphing meshes 326 such that the user can select accessories for the particular avatar 510 or morphed versions of the avatar 510 without individually resizing the accessories. For example, if the user morphs the avatar 510 to have wider hips, a pair of shorts 526 worn by the avatar 510, automatically morph to the wider hip configuration.

The geometry files 314 include a morph stack 316, skinned morphing meshes 326 and stripped delta morphs 328. The morph stack 324 and skinned morphing meshes 326 define the positions of the vertices as well as morph targets for alternate positions for the vertices. Thus, the shape of the entire avatar 510 and accessories can be customized. A delta morph allows vertices to be moved to an alternate position relative to a current position. Thus, delta morphs allow the user to combine morphs together to create an unlimited or large number of personalization options. The stripped delta morphs 328 allow space to be saved in the data structure 300 by saving and using only alternate vertex positions that actually change. For example, if the head portion 518 includes approximately 2000 vertices, but only approximately 50 vertices on the nose are used in a morph, only the 50 changed vertices are saved in the stripped delta morphs 328.

The texture files 318 include a texture stack 330 for controlling the texture map and color of any individual part on the avatar 510. For example, the user can independently change the avatar's eye color, skin color, the color of the shorts 526 or any other accessory, or place a logo or tattoo on the avatar 510. In one embodiment, a masking layer is used to achieve full transparency layering affects. For example, the user can layer a t-shirt underneath the avatar's camisole or add a hole in the knee of the avatar's blue jeans. As another example, the user may change the transparency so that a dark colored tank-top is partially visible through a white t-shirt.

The user can also replace, add or remove texture layers to further personalize the avatar 510. For example, a user may add a pair of socks between a skin layer and a shoe layer. As another example, a user can rearrange the order of a t-shirt layer and a tank-top layer so as to select which accessory to display at least partially over the top of the other accessory. When the user is finished personalizing the colors and/or textures of the avatar 510, a flattened version of the texture stack 330 is used for rendering. As discussed above, FIG. 4 represents a flattened file 400 that can be used to render the avatar 510.

An example texture stack 330 is graphically illustrated in FIG. 5. As shown, the texture stack 330 comprise one or more sub-stacks 528, 530, 532, 534, 536 corresponding to a respective portion of the avatar 510. For example, the sub-stack 532 corresponds to the top portion 520 of the avatar 510 and the sub-stack 534 corresponds to the bottom portion 522 of the avatar 510. The sub-stacks 528, 530, 532, 534, 536 each include one or more image layers. For example, the sub-stack 528 includes a long-hair layer 538. As another example, the sub-stack 532 includes a skin layer 540, a t-shirt layer 542, and a logo layer 544.

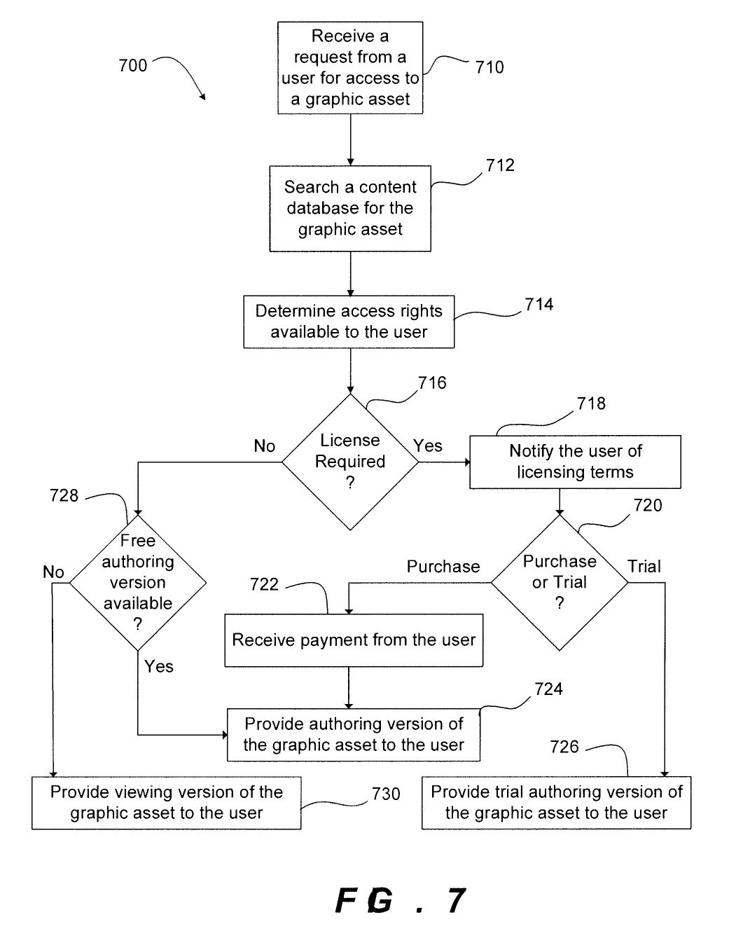

The image layers (e.g., layers 538, 540, 542, 544) each comprise an image file (e.g., a jpg, bmp, tiff, or other image file format). In one embodiment, the image files are named using a predetermined naming scheme. For example, FIG. 6 is a graphical representation of an example naming scheme for image layer files according to one embodiment. As shown, the image layer files are named using a layer name 610, a part name 612 corresponding to a sub-stack or portion of the avatar 510, a sub-stack order 614 for defining the location of the image layer within its corresponding sub-stack, an artists name 616 (or pseudonym), and an artist and product unique identifier (ID) 618.

In the full texture stack 330, each layer may have a unique name 610. However, certain layers may have the same name so that the texture or color of the related layers can be changed by a single user action. For example, as shown in FIG. 5, the sub-stacks 530, 532, 534, 536 each have a layer named “skin.” Thus, to change the skin color for the entire avatar 510, the user only needs to see and edit one of the skin layers.

The artist name 616 and artist and product ID 618 may be used, for example, to identify an owner (e.g., artist and/or publisher) for licensing purposes. As shown, the file name also includes a file extension 620 to identify the format of the image file.

In a conventional 3D graphics environment, a human figure model, for example, may have one texture map for the head and another texture map for the body. The body map, for example, may have different colors for a shirt, skin, pants and shoes. Rather than being able to select separate colors, an end user of a conventional texture map can only tint the color of the entire map. Tinting adds a color to the colors that already exist in the texture map. For example, to change a blue shirt to purple, an end-user of a conventional texture map adds red to the texture map. However, adding red to change the color of the shirt also changes the color of the skin, pants and shoes.

By separating the texture map into separate image layers (e.g., e.g., layers 538, 540, 542, 544 shown in FIG. 5), the color of each layer can be independently tinted or replaced. The texture sub-stacks 528, 530, 532, 534, 536 are flattened after the user makes any changes to a layer and are applied to the 3D model in real-time. Thus, in one embodiment, the user can change the color of any image layer via a user interface and see the results fully rendered on the 3D model.

Returning to FIG. 3, in an alternative embodiment, the scheme for naming image layer files within a texture stack 330 (as illustrated in FIG. 6) may be accomplished, instead, using eXtensible Markup Language (XML) data 331. XML provides for greater compatibility and interchangeability between different types of devices.

The animation files 320 include keyframe information that defines fixed points in time through which the animation passes. Animation between these keyframes is calculated by an application animating the avatar 510. An artisan will recognize from the disclosure herein that the animation files 320 may include other information for animating the avatar 510 and that other animation techniques may be used.

The sound files 321 may include sound recordings, sound effects, synthesized music (including ring tones), and the like. The sound files 321 may be stored in various formats, such as MPEG Layer 3 (MP3), Advanced Audio Coder (AAC), Windows Media Audio (WMA), Pulse Code Modulation (PCM), Musical Instrument Digital Interface (MIDI), and the like.

The marketing information 322 is used to allow users to share the avatar 510 and/or avatar accessories and includes authorship and/or publisher information. As discussed above, the authorship and/or publisher information may be derived from the file names in the texture stack 330. In one embodiment, the marketing information 322 may also includes a link 334 that automatically directs the user's cell phone to product, licensor, and/or licensing information. In one embodiment, each layer in the texture stack 330 shown in FIG. 5 may be licensed separately from one or more licensors. In another embodiment, two or more layers in the texture stack 330, or the entire avatar 510 with accessories, may be licensed as a group from a single licensing entity.

In one embodiment, the marketing information 322 includes one or more unique user identifiers (IDs) 336 to identify a source or chain of sources that provided an end-user with a copy of the avatar 510 and/or avatar accessory. The user IDs 336 may correspond, for example, to the users' respective cell phone numbers. In one embodiment, the user IDs 336 are used to provide incentives to users to display or market licensed avatars and/or avatar accessories to other users.

For example, in one embodiment, when a user follows the link 334 to a web page of a licensor of an avatar accessory and purchases a license to the avatar accessory, the licensor provides points or credits to one or more users identified by the user IDs 336. The points or credits can then be used by the one or more identified users to purchase additional avatars or avatar accessories. In one embodiment, only a most recent user identified by the user IDs 336 is provided points or credits. In another embodiment, the most recent user is provided more points or credits than earlier users identified by the user IDs 336.

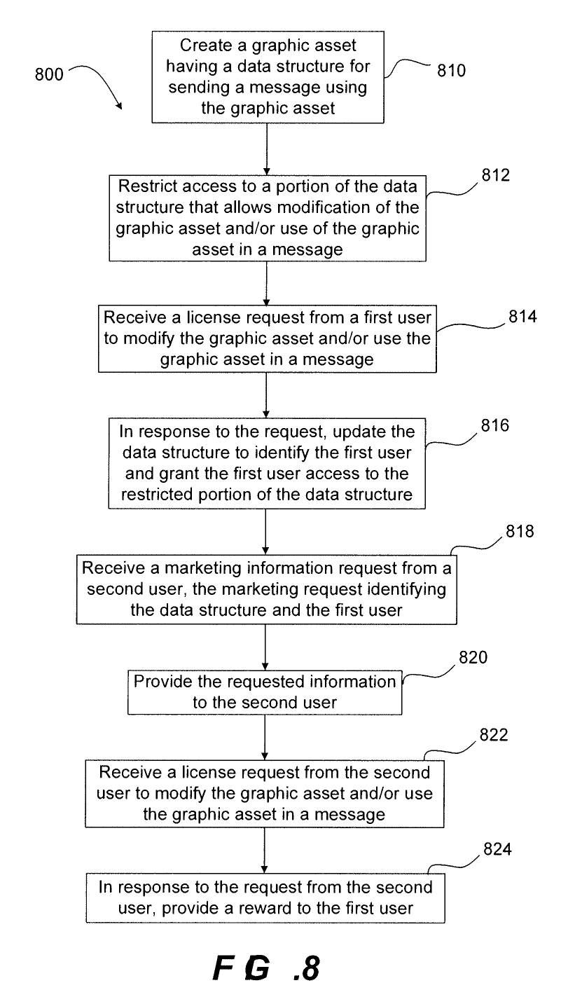

FIG. 7 is a flow chart illustrating a method 700 for distributing a graphic asset according to one embodiment. As discussed above, the graphic asset may include an avatar and/or an avatar accessory used to send a message between users. The method 700 includes receiving 710 a request from a user for access to the graphic asset. As discussed above, portions of the graphic asset may be locked or restricted such that the user cannot modify the graphic asset or use the graphic asset to send a message to another user.

In response to the request, the method 700 includes searching 712 a content database for the graphic asset. Once the graphic asset is identified in the content database, the method 700 determines 714 what access rights, if any, are available to the user. The access rights may include, for example, rights to modify and send messages using the graphic asset for a one-time fee, for a periodic (e.g., weekly, monthly, daily) renewal fee, or for free. The access rights may be determined by, for example, a creator of the graphic asset, a publisher of the graphic asset, a content portal administrator, a combination of the foregoing, or the like.

The access rights are used to determine 716 whether a license is required to modify or use the graphic asset to send a message to another user. If a license is required, the method 700 notifies 718 the user of licensing terms available to the user. In one embodiment, the licensing terms may provide the user with an option 720 to purchase a license to modify or user the graphic asset or to use a trial version of the graphic asset for a predetermined period of time.

If the user decides to purchase a license, the method 700 receives payment from the user for the purchase price of the license and provides 724 an authoring version of the graphic asset to the user. As discussed above, the authoring version allows the user to modify (e.g., shape, texture, transparency and/or colors) of the graphic asset and use the graphic asset to send messages to other users. If the user decides to download a trial version of the graphic asset, the method 700 provides 726 a trial authoring version of the graphic asset to the user. In one embodiment, the user has access for a limited time to modify the trial graphic asset. However, the user cannot use the trial graphic asset to send messages to other users.

If a license is not required for the graphic asset, the method determines 728 whether a free authoring version is available. Certain free avatars and/or avatar accessories may be available, for example, to entice users into purchasing additional avatars and/or avatar accessories. If a free authoring version is available, the method 700 provides 724 the authoring version of the graphic asset to the user. In one embodiment, if a free authoring version is not available, the method 700 provides 730 a viewing version of the graphic asset to the user. As discussed above, the user may view the viewing version but does not have access to save the graphic asset, modify the graphic asset or use the graphic asset to send a message to another user.

FIG. 8 is a flow chart illustrating a method 800 for marketing graphic assets according to one embodiment. The method 800 includes creating 810 a graphic asset having a data structure for sending a message using the graphic asset. The method 800 further includes restricting 812 access to a portion of the data structure that allows modification of the graphic asset and/or use of the graphic asset in a message.

The method 800 also includes receiving 814 a license request from a first user to modify the graphic asset and/or use the graphic asset in a message. In response to the request, the method 800 includes updating 816 the data structure to identify the first user and grant the first user access to the restricted portion of the data structure. As discussed above, access may be provided by providing the first user with a decryption key for decrypting the restricted portion of the data structure. In another embodiment, access may be provided by providing the first user with a non-encrypted version of the data structure. Once the first user has access to the restricted portion of the data structure, the first user can modify the graphic asset and send the graphic asset to a second user.

The method 800 also includes receiving 818 a marketing request from the second user. The marketing request identifies the data structure and the first user. The marketing request also requests information related to purchasing or licensing the graphic asset. In response to the marketing request, the method 800 provides the requested information to the second user. The method further includes receiving 822 a license request from the second user to modify the graphic asset and use the graphic asset in a message. In response to the licensing request from the second user, the method 800 provides 824 a reward to the first user. The reward may be in the form of, for example, a cash payment, a coupon, a credit, points that can be used toward the purchase of the graphic asset or other graphic assets, combinations of the foregoing, or the like.

Various modifications, changes, and variations apparent to those of skill in the art may be made in the arrangement, operation, and details of the methods and systems of the disclosure without departing from the spirit and scope of the disclosure. Thus, it is to be understood that the embodiments described above have been presented by way of example, and not limitation, and that the invention is defined by the appended claims.

What is claimed is:

1. A method for distributing a graphic asset among personal communication devices, the method comprising:
providing a first user with an authoring version of the graphic asset, the authoring version allowing the first user to send a viewing version of the graphic asset directly to a second user;
receiving a request from the second user to license the graphic asset, the viewing version allowing the second user to render the graphic asset; and
in response to the request, providing the authoring version of the graphic asset to the second user.

2. The method of claim 1, wherein the authoring version further allows the first user to modify the graphic asset.

3. The method of claim 2, wherein modifying the graphic asset comprises changing one or more morph targets corresponding to the graphic asset.

4. The method of claim 2, wherein modifying the graphic asset comprises changing a color corresponding to the graphic asset.

5. The method of claim 4, wherein changing the color comprises modifying an image file in a texture stack, the image file corresponding to the graphic asset.

6. The method of claim 5, further comprising flattening the texture stack.

7. The method of claim 1, wherein the authoring version further allows the first user to include a personal message intended for the second user in the viewer version of the graphic asset.

8. The method of claim 1, wherein the viewing version is a flattened version of the authoring version.

9. The method of claim 1, wherein the viewing version comprises a UV map corresponding to a three dimensional graphic.

10. The method of claim 1, wherein the viewing version comprises an at least partially encrypted version of the authoring version.

11. The method of claim 10, wherein providing the authoring version of the graphical asset to the second user comprises providing decryption data to the second user.

12. The method of claim 1, wherein the second user is prevented from storing the viewing version in non-volatile storage.

13. The method of claim 1, wherein the second user is allowed to store the viewing version in non-volatile storage.

14. The method of claim 1, wherein the second user is prevented from using the viewing version to modify the graphic asset.

15. The method of claim 1, wherein the second user is prevented from inserting a personal message in the viewing version of the graphic asset.

16. The method of claim 1, wherein the authoring version allows the second user to modify the graphic asset.

17. The method of claim 15, wherein the authoring version further allows the second user to send a modified viewer version to at least one of the first user and a third user.

18. The method of claim 1, wherein the graphic asset comprises at least one of an avatar and avatar accessory.

19. The method of claim 18, wherein the avatar accessory is selected from the group comprising virtual shirts, pants, shorts, socks, hats, headbands, wristbands, shoes, glasses, headphones, logos, tattoos, hair styles, jewelry, and animation.

20. The method of claim 1, wherein the viewing version includes marketing information for licensing the authoring version of the graphic asset.

21. The method of claim 20, wherein the marketing information includes a link to a licensor of the graphic asset.

22. A system for exchanging graphics between personal communication devices, the system comprising:
a content portal comprising:
a content database for storing data structures corresponding to message graphics, the message graphics configured to deliver messages between users in a personal communication system, the data structures respectively comprising restricted portions thereof that prevent unauthorized use of the message graphics; and
a content distribution module for selectively granting access to the restricted portions of the data structures and tracking distribution of the data structures between the users in the personal communication system

23. The system of claim 22, wherein the content distribution module comprises a web page accessible to the users of the personal communication system to download the data structures.

24. The system of claim 23, wherein the content distribution module further comprises an interface for downloading the data structures through a cellular telephone network.

25. The system of claim 22, wherein the content portal further comprises an administration module for managing one or more online activities selected from the group comprising development, testing, marketing, and licensing of the message graphics.

26. The system of claim 22, wherein the content portal further comprises a content creator module for providing development tools to create the message graphics.

27. A method for communicating a data structure in a cellular communication system, the data structure corresponding to a graphic asset, the method comprising:
providing first decryption data to a first user, the first decryption data allowing the first user to modify a restricted portion of the data structure and to send the modified data structure to a personal communication device corresponding to a second user; and
providing second decryption data to the second user, the second decryption data allowing the second user to further modify the restricted portion of the modified data structure.

28. The method of claim 27, wherein the second decryption data further allows the second user to send the modified data structure to at least one of the first user and a second user.

29. The method of claim 27, further comprising providing an unmodified version of the data structure to the second user.

30. The method of claim 27, wherein the modified data structure sent to the second user by the first user comprises alternate vertex positions selected by the first user so as to morph the graphic asset.

31. The method of claim 27, wherein the restricted portion of the data structure comprises a texture stack comprising a series of separable image files respectively corresponding to different portions of the graphic asset.

32. The method of claim 31, further comprising flattening the texture stack.

33. The method of claim 27, wherein the modified data structure sent to the second user by the first user comprises a personal message from the first user to the second user.

34. A data structure stored in a machine-readable medium for communicating between personal communication devices, the data structure comprising:
message data corresponding to a communication from a first user to a second user;
graphics data for rendering a graphic asset; and
marketing data for identifying a licensor of the graphic asset.

35. The data structure of claim 34, wherein the marketing data comprises a link to a web page comprising information related to the graphic asset.

36. The data structure of claim 35, wherein the information related to the graphic asset comprises licensing information.

37. The data structure of claim 34, wherein the marketing data comprises a link to an interface accessible through a cellular telephone.

38. The data structure of claim 37, wherein the interface comprises licensing information related to the graphic asset.

39. The data structure of claim 34, wherein the marketing data comprises the identity of the first user.

40. The data structure of claim 34, further comprising sound data.

41. The data structure of claim 34, further comprising animation data.

42. A system for distributing graphics content to personal communication devices, the system comprising:
means for receiving graphic assets from a plurality of content providers;
means for storing the graphic assets;
means for receiving user requests to view the graphic assets; and
means for unlocking access to the graphic assets such that the unlocked graphic assets can be used to send messages between personal communication devices.

43. The system of claim 42, wherein the unlocked graphic assets are capable of being user modified.

44. The system of claim 42, further comprising means for coordinating the creation of the graphic assets by the content providers.
